(19) United States
(12) Patent Application Publication
(10) Pub. No.: US 2023/0157327 A1
(43) Pub. Date: May 25, 2023

(54) WATER DRINK COMPRISING A FRUIT FLAVOR AND A PROCESS FOR PREPARING SAID WATER DRINK

(71) Applicant: West Invest SA, Luxembourg (LU)

(72) Inventors: Eric Reynaud, Luxembourg (LU); Jacques Meurisse, Meylan (FR)

(21) Appl. No.: 17/921,760

(22) PCT Filed: Apr. 26, 2021
(86) PCT No.: PCT/IB2021/053412

§ 371 Date: Oct. 27, 2022

Related U.S. Application Data
(60) Provisional application No. 63/015,800, filed on Apr. 27, 2020.

(51) Int. Cl. A23L 2/74; A23L 2/02

(52) U.S. Cl. CPC A23L 2/74; A23L 2/02

(57) ABSTRACT

The disclosure generally relates to a an aromatic water having fruit flavors without artificial or added aromas from fruit juices comprising produced by a process comprising providing a fruit juice, performing a nanofiltration of said fruit juice or adjusted fruit juice through a nanofiltration membrane, and recovering the permeate water from the nanofiltration to obtain the aromatic water drink, wherein the permeate water has a reduced Brix degree by at least 50% compared to the fruit juice.

### CROSS-REFERENCE TO RELATED APPLICATION

The present application is claiming priority from U.S. Provisional Application No. 63/015,800 filed Apr. 27, 2020, the content of which is hereby incorporated by reference in its entirety.

### FIELD OF THE DISCLOSURE

The disclosure generally relates to a process for preparing water having fruit flavors without artificial or added aromas from fruit juices.

### BACKGROUND OF THE DISCLOSURE

Membrane processes are widely used in the water treatment, agro-food and chemical industries in general. For many years, membranes have been used to produce purified water from raw water. Depending on the water to be treated, the reverse osmosis membrane system can be adapted to obtain an osmosis water with various amounts of salt present in the water.

By decreasing the retention of membranes, mineral salts and small molecules have the possibility of crossing the membrane. Thus nanofiltration membranes, which have a low rejection for NaCl, have been developed but retain larger molecules such as MgCl₂, which is often used as a nanofiltration rejection standard. The cut-off threshold of the nanofiltration membranes is between 100 and 1000 Da.

These membranes are used in agro-food and chemical industries to separate water and small molecules from solutions containing larger molecules. Thus, it is possible to separate monosaccharides from disaccharides, monovalent ions from multivalent ions, etc.

The fruit juice industry works from raw or concentrated juices. The concentrated juices are obtained by evaporation which can be coupled with a reverse osmosis step as a pretreatment. The use of these natural and relatively expensive concentrated fruit waters have been further supplemented with aromas made by the flavor industry. The juice industry uses the concentration of juice under vacuum and the recovery of aromatic volatiles that have suffered aromatic loss due to processing.

Unfortunately, evaporation processes will normally result in water being disposed of and a potential loss of valuable volatile aromatic molecules.

There is thus still a need to be provided with improved juices.

### SUMMARY OF THE DISCLOSURE

It is provided an aromatic water drink obtained from a fruit juice comprising a reduced Brix degree of at least 50% compared to the fruit juice.

In an embodiment, the aromatic water drink is produced following the steps of:
providing a fruit juice,
optionally adjusting the Brix sugar degree and/or pH of said fruit juice at a predetermined Brix degree and/or pH value to provide an adjusted fruit juice;
performing a nanofiltration of said fruit juice or adjusted fruit juice through a nanofiltration membrane; and
recovering the permeate from said nanofiltration to obtain said water drink.

A further aspect relates to an aromatic water drink prepared by the process as defined herein.

An aspect relates to an aromatic water drink from (or derived from) a fruit juice or adjusted fruit juice at least comprising one of the feature of a reduced Brix degree, a reduced glucose concentration and a reduced amount of one or more organic acids, relative to said fruit juice or adjusted fruit juice.

In an embodiment, the fruit just is an adjusted fruit juice.

In another embodiment, the adjusted fruit juice has been pH adjusted.

In a further embodiment, the permeate water has a Brix degree reduced by at least about 70%, by at least about 85%, or preferably by at least about 90-95%.

In accordance to another embodiment, the permeate water has a glucose concentration reduced by at least 50% relative to the glucose concentration of the fruit juice, preferably at least about 70%, at least about 85%, more preferably at least about 90-95%.

In another embodiment, the fruit juice is at least one of cranberry juice, pomegranate juice, pineapple juice, Camerise juice, Blackcurrant juice, Redcurrant juice, Blueberry juice, Blackberry juice, Strawberry juice, Raspberry juice, Acai juice, Acerola juice, Goji berry juice, Cynorhodon juice, Arbutus juice, Myrtle juice, Guarana juice, Coffee berry juice, Cola nuts juice, maracuja juice, goyava juice, mango juice, apple juice, pear juice, peach juice, plume juice, blood-orange grapefruit juice, lemon juice, lime juice, mandarin juice, clementine juice or tangerine juice.

In a further embodiment, the fruit juice has a brix concentration from 3 to 15, a brix concentration of 5 to 10.

In an embodiment, the nanofiltration membrane has a cut-off threshold of from about 300-800 Da, preferably from about 300-500 Da, particularly from about 500-700 Da, more preferably from about 600-800 Da.

In another embodiment, the nanofiltration membrane is Filmtec NF90, Filmtec NF270, NFW Synder, Trisep NP10, NFG Synder, or NDX Synder.

### DESCRIPTION OF THE DRAWINGS

FIG. 1 illustrates a flow chart depicting the process for preparing an aromatic water drink in accordance to an embodiment.

### DETAILED DISCLOSURE

It is provided a process for preparing an aromatic water drink comprising providing a fruit juice, performing a nanofiltration of said fruit juice or adjusted fruit juice through a nanofiltration membrane, and recovering the permeate water from the nanofiltration to obtain the water drink, wherein the permeate water has a reduced Brix degree by at least 50% compared to the fruit juice.

Fruit juices are suitable starting material to provide a water drink containing a fruit flavor, color or a visual aspect similar or related to that of the fruit juices. The water drink as defined herein may be an ingredient for food industry formulas or water drink or sparkling juice water drink comprising the endogenous natural fruit flavor (preferably without added exogenous flavor). The disclosure provides a physical (i.e. non-chemical) process for preparing water drink or sparkling juice water drink, from fruit juices.

The fruit water provided herewith, with Brix degree of for example around 3° has a low amount of sugars (sucrose; glucose and fructose), resulting in a very low brix but still, can be used as an “aromatic water” to formulate fruit drinks of the “sparkling juice water” type, to re-balanced fruit juices comprising a reduction in total sugars, without denaturing the taste of the products and its aromatic power, while retaining the nutritional value of e.g. versus Vitamin C, Beta-carotenoid and minerals.

The proportion of integration of this “aromatic water” in the reconstituted and re-balanced product can reach 50 to 60%.

Accordingly, as described herein, fruit juices can be circulated through nanofiltration membranes to provide permeates that, depending on the porosity of the membranes used, will provide, to a larger or limited extent as desired, water with one or more features corresponding to the original fruit juice, such as an aromatic taste, color or astringency of the original fruit juice.

In one embodiment, the water drink described herein does not contain added sugars, masking agent, such as a base or a chelating agent, or buffer or artificial colors.

In one embodiment, the water drink described herein does not contain artificial or extrinsic colors, dyes or aromas.

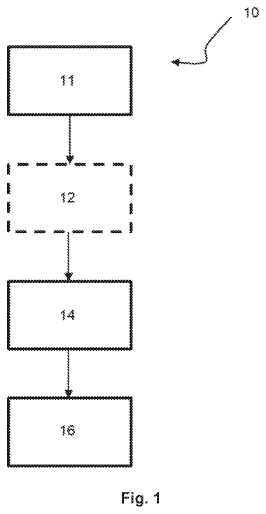

As seen FIG. 1, the aromatic water drink 16 as described herein is obtained following the process 10 as illustrated. Firstly, fruit juice 11 can be adjusted such as e.g. pH adjusted through a deacidification column 12. The fruit juice or adjusted fruit juice is then filtered by reverse osmosis through a nanofiltration membrane 14 in order to obtain a permeate 16 consisting of the aromatic water drink as described herein.

As used herein, “adjusted fruit juice” refers to a juice that has been concentrated, diluted or pH adjusted. Preferably, the pH adjustment is conducted using the process described in WO20180549004 A1.

In certain embodiments the permeate water has a Brix degree reduced by at least 50%, or at least about 70% or preferably at least about 85% or preferably at least about 90-95% relative to the Brix degree of said fruit juice or adjusted fruit juice.

In certain embodiments the permeate water has a glucose concentration reduced by at least 50%, or at least about 70% or preferably at least about 85% or preferably at least about 90-95% relative to the glucose concentration of said fruit juice or adjusted fruit juice.

In certain embodiments the permeate water has an amount of one or more organic acids reduced by at least 50%, or at least about 70% or preferably at least about 85% or preferably at least about 90-95% relative to the amount of one or more organic acids of said fruit juice or adjusted fruit juice.

In certain embodiments the permeate water has pH value not substantially different from the pH of said fruit juice or adjusted fruit juice, preferably the pH does not vary more than about 0.5 pH units, preferably not more than about 0.4 pH units, about 0.3 pH units or preferably about 0.2-0.1 pH units relative to the pH of said fruit juice or adjusted fruit juice.

In one embodiment the fruit juice or adjusted fruit juice is comprising cranberry juice, pomegranate juice, pineapple juice, Camerise (Family: Honeysuckle), Pomegranate (Malum granatum), Blackcurrant (Family: Grossulariaceae), Redcurrant (Family Grossulariaceae, Ribes rubrum, Ribes uva-crispa et Ribes nigrum), Blueberry (Vaccinum & Myrtillus), Blackberry (Meuron/Rubus), Strawberry (Fragaria—Family: Rosaceae & Fragaria vesca & Fragaria virginiana), Raspberry (Rubus Idaeus), Acai (Euterpe oleracea), Acerola (Carathe cherry), Goji berry (Lycium barbarum or chinense Family: Solanacées), Cynorhodon (fruit of Eglantier), Arbutus (Arbutus unedo Family: Ericaceae), Myrtle (Myrtus communis Family: Myrtacees), Guarana (Paullinia cupana), Coffee berry (Coffee tree), Cola nuts (Colatier/Cola nitida or Acuminata Family: Sterculiaceae), and the like, exotic fruits like: maracuja, goyava, mango and pineapple as well as fruits like: apple, pear, peach, plume, and citrus fruit like: orange, blood-orange grapefruit, lemon, lime, mandarin, clementine and tangerine.

Preferably to perform the nanofiltration step, the fruit juice or adjusted fruit juice has a brix concentration of from 3 to 15, or preferably 5 to 10.

In certain embodiments the pH of said fruit juice or adjusted fruit juice ranges from 2 to 5 or more preferably from 2.5 to 4.

In certain embodiments, the nanofiltration membrane preferably has a cut-off threshold of from about 300-800 Da, such as from about 300-500 Da, or about 500-700 Da, or about 600-800 Da. It is encompassed that the nanofiltration membrane can be for example, but not limited to, Filmtec NF90, Filmtec NF270, NFW Synder, Trisep NP10, NFG Synder, or NDX Synder.

As provided herein, after deacidification of black currant juice aromatic waters were produced from the juice obtained. These aromatic waters have been evaluated and present certain aromatic interests. It is described that, molecules quite characteristic of the blackcurrant fruit were detected on the nose and also on the taste e.g. (butter, bud, fruity, linalool, geraniol, citronellyl acetate, as well as at the bottom it was distinguish, slightly behind the notes sabinene, and beta pinene, as well as a number of sulfur notes, thiophenes, methyl sulphide and its derivatives).

Accordingly, the water drink or aromatized water encompassed herein have several uses in the aromatic industry as an extract natural. In an embodiment, the products water drink or aromatized water can be further concentrated in the order of 30 to 50 times.

The presence of sulfur notes (thiophenes and methyl sulfides and derivatives) as well as acetaldehyde and derivatives, acetone, methyl acetate ethyl acetate and also acetic were detected in the acid water drink or aromatized water encompassed herein. There is also a little nitroso methyl methane of high interest. Accordingly, it is encompassed that the water drink or aromatized water described herein be use in aromatic formulation as part of the construction of a true natural aroma, e.g. blackcurrant. It is encompassed developing a natural blackcurrant flavor for example from deacidified juice, therefore having perfectly preserved its original color. Finally, these formulations can be supplemented with a natural aromatic dose reinforced and containing acetaldehyde, sabinene, beta pinene, linalool geraniol to strengthen the final product.

This aromatic base can be advantageously used in syrups, soft drinks, ice creams, sorbets, yogurts and fresh cheeses. All types of sour red fruits (Cranberries, pomegranate, raspberry) or exotic (passion, pineapple acerola, etc.) can be used as starting materials.

The presence, at the “head space” level, of the following molecules confirms that the process described herein provides a mean to produce a water drink or aromatized water that can be used as described herein: cinnamalaldehyde, aldehyde C-14, amyl butyrate, amyl benzoate, ethyl benzoate, amyl acetate, ethyl acetate, methyl-2-butenoic acid, 2-ethylhexanol, acetic acid, acetone, acetaldehyde, and ethyl valerate.

Accordingly, it is provided a real aromatic water which can be used as a vector for drinks (e.g. sparkling waters) but also be concentrated, even distilled to be able to have bases concentrated aromatics. The water can also comprise and conserve minerals of interest such as calcium, sodium, potassium phosphorus, silicon and magnesium.

### EXAMPLES

The limit of the developed process was evaluated by testing different osmosis and nanofiltration membranes:

| | Cutoff | Sugar | Divalent Salt | Monovalent Salt | Membrane |
|---|---|---|---|---|---|
| Membrane | Threshold | Rejection | Rejection | Rejection | Tested |
| Type | Da | % Feed Concentration | | | |
| Reverse | <100 | >99.9 | >99.9 | 99.8 | FILMTEC SWHR |
| osmosis | | | | | |
| Nanofiltration | 100-250 | 99.5 | 99.5 | 50.0 | FILMTEC NF90 |
| | 150-300 | 99.0 | 99.0 | 40.0 | FILMTEC NF270 |
| | 300-500 | 98.5 | 97.0 | 20.0 | SYNDER NFW |
| | 600-800 | 60.0 | 50.0 | 10 | Trisep NP10 |

Reverse Osmosis/Nanofiltration Set Up

The set up consists of a 4-liter feed tank, a 250 l/h gear pump at 17 bar, a manometer, a filtration module with up to four parallel cellulosic flat membranes. The tank can be thermostated using an external circulating thermostat/cryostat.

Deacidification Process of Fruit Juices

The juice used herein were deacidified in accordance with the process disclosed in WO20180549004 A1.

### Example 1 Reverse Osmosis on Cranberry Deacidified Juice

The cranberry juice is deacidified according to the method described in WO20180549004 A1. The raw juice had a concentration of 7 brix. After deacidification, the brix of the juice was 5.4 which is related to the acid capture replaced by water and the dilution corresponding to the rinsing of the ion exchange column.

The reverse osmosis membrane was a Filmtec SWHR 2540 and provided the results in the following table:

| Elapse Time | Press. | VOLUME (I) | | | Permeate Flow Rate | | | BRIX | | | |
|---|---|---|---|---|---|---|---|---|---|---|---|
| Minutes | BAR | Feed | Retent | Perm | l/h | l/h · m² | VCF | Retentate | Feed | Perm | ABS 420 nm |
| 0 | 35 | 20 | 20 | 0 | 115 | 42.6 | 1.0 | 5.4 | 5.4 | 0 | 0 |
| 5 | 35 | 30 | 20 | 10 | 114 | 42.2 | 1.5 | 8.0 | 5.4 | 0 | 0 |
| 10 | 35 | 38 | 20 | 18 | 106 | 39.3 | 1.9 | 10.4 | 5.4 | 0 | 0 |
| 15 | 35 | 47 | 20 | 27 | 99 | 36.7 | 2.3 | 12.6 | 5.4 | 0 | 0 |
| 20 | 35 | 54 | 20 | 34 | 89 | 33.0 | 2.7 | 14.6 | 5.4 | 0 | 0 |
| 25 | 35 | 61 | 20 | 41 | 79 | 29.3 | 3.0 | 16.4 | 5.4 | 0 | 0 |
| 30 | 35 | 66 | 20 | 46 | 68 | 25.2 | 3.3 | 17.9 | 5.4 | 0 | 0 |
| 35 | 35 | 71 | 20 | 51 | 54 | 20.0 | 3.5 | 19.1 | 5.4 | 0 | 0 |
| 40 | 35 | 74 | 20 | 54 | 41 | 15.2 | 3.7 | 20.0 | 5.4 | 0 | 0 |
| 45 | 35 | 77 | 20 | 57 | 32 | 11.9 | 3.8 | 20.7 | 5.4 | 0 | 0 |
| 50 | 35 | 79 | 20 | 59 | 25 | 9.3 | 3.9 | 21.3 | 5.4 | 0 | 0 |
| 55 | 35 | 81 | 20 | 61 | 21 | 7.8 | 4.0 | 21.8 | 5.4 | 0 | 0 |
| 60 | 35 | 82 | 20 | 62 | 17 | 6.3 | 4.1 | 22.2 | 5.4 | 0 | 0 |
| 65 | 35 | 83 | 20 | 63 | 13 | 4.8 | 4.2 | 22.5 | 5.4 | 0 | 0 |
| 70 | 40 | 84 | 20 | 64 | 9 | 3.3 | 4.2 | 22.7 | 5.4 | 0 | 0 |
| 75 | 40 | 82 | 18 | 64 | 3 | 1.1 | 4.3 | 23.2 | 5.4 | 0 | 0 |
| 80 | 40 | 82 | 18 | 64 | 0 | 0.0 | 4.3 | 23.2 | 5.4 | 0 | 0 |

*VCF: Volumic Concentration Factor

A maximum concentration of 23.2 brix is reached in the retentate without any material found in the permeate. The average flow rate of the filtration is 48 l/h for a maximum pressure of 40 bars. The maximum VCF achieved is 4.3. the water recovered contains neither aroma nor color.

Measurement of the refractive index or Brix:

The Brix level are measured for example by using the principle that a solid in solution in a liquid modifies the refractive index of the liquid in proportion to their concentration. Thus the Brix level reflects the measure of the concentration in solutes from a refractometer calibrated on sucrose. For example, a drop of liquid at 20° C. is placed on the measurement cell of the REICHERT R2i300.

The free acidity is measured based by the addition of NaOH until turning a colored indicator (phenolphthalein) which makes it possible to measure the free acids. A 50 ml aliquot of solution is taken and 5 drops of phenolphthalein are added. The product is titrated with 1M NaOH until the color indicator changes (V ml). Free acidity=V/50: acidity free expressed in mole/liter.

In order to measure the optical density, the wavelength of 420 nm was selected. The solution is filtered through a filter of 0.45 μm and diluted to be measured such that the absorbance does not exceed 1 Unit. A measuring cuvette is filled and place into a cuvette holder of a VWR UV/VIS 1600 PC spectrophotometer. The result is expressed directly in absorbance unit.

### Example 2 Nanofiltration of Deacidified Cranberry Juice

The cranberry juice is identical to that of Example 1. The crude juice at a concentration of 7 brix. After deacidification, the brix of the juice is only 5.4. This is related to the acid capture replaced by water and the dilution corresponding to the rinsing of the ion exchange column.

The nanofiltration membrane used was a Filmtec NF90 and provided the results in the following table:

| Elapse Time | Press. | VOLUME (I) | | | Permeate Flow Rate | | | BRIX | | | |
|---|---|---|---|---|---|---|---|---|---|---|---|
| Minutes | BAR | Feed | Retent | Perm | l/h | l/h · m² | VCF | Retentate | Feed | Perm | ABS 420 nm |
| 0 | 20 | 20 | 20 | 0 | 115 | 42.6 | 1.0 | 5.4 | 5.4 | 0 | 0 |
| 5 | 20 | 28 | 20 | 8 | 101 | 37.4 | 1.4 | 7.7 | 5.4 | 0 | 0 |
| 10 | 20 | 36 | 20 | 16 | 95 | 35.2 | 1.8 | 9.8 | 5.4 | 0 | 0 |
| 15 | 20 | 44 | 20 | 24 | 88 | 32.6 | 2.2 | 11.8 | 5.4 | 0 | 0 |
| 20 | 20 | 50 | 20 | 30 | 79 | 29.3 | 2.5 | 13.6 | 5.4 | 0 | 0 |
| 25 | 20 | 56 | 20 | 36 | 72 | 26.7 | 2.8 | 15.2 | 5.4 | 0 | 0 |
| 30 | 20 | 61 | 20 | 41 | 61 | 22.6 | 3.1 | 16.6 | 5.4 | 0 | 0 |
| 35 | 20 | 66 | 20 | 46 | 53 | 19.6 | 3.3 | 17.8 | 5.4 | 0.1 | 0 |
| 40 | 20 | 70 | 20 | 50 | 47 | 17.4 | 3.5 | 18.8 | 5.4 | 0.1 | 0 |
| 45 | 20 | 73 | 20 | 53 | 39 | 14.4 | 3.6 | 19.7 | 5.4 | 0.2 | 0 |
| 50 | 25 | 76 | 20 | 56 | 32 | 11.9 | 3.8 | 20.4 | 5.4 | 0.2 | 0 |
| 55 | 25 | 77 | 20 | 57 | 21 | 7.8 | 3.9 | 20.9 | 5.4 | 0.2 | 0 |
| 60 | 25 | 79 | 20 | 59 | 17 | 6.3 | 3.9 | 21.3 | 5.4 | 0.2 | 0 |
| 65 | 25 | 80 | 20 | 60 | 15 | 5.6 | 4.0 | 21.6 | 5.4 | 0.2 | 0 |
| 70 | 25 | 81 | 20 | 61 | 11 | 4.1 | 4.0 | 21.8 | 5.4 | 0.2 | 0 |
| 75 | 25 | 82 | 20 | 62 | 9 | 3.3 | 4.1 | 22.1 | 5.4 | 0.2 | 0 |
| 80 | 25 | 82 | 20 | 62 | 7 | 2.6 | 4.1 | 22.2 | 5.4 | 0.3 | 0 |
| 85 | 25 | 83 | 20 | 63 | 3 | 1.1 | 4.1 | 22.3 | 5.4 | 0.3 | 0 |

A maximum concentration of 22.3 brix is reached in the retentate without any loss of material in the permeate. The average flow rate of the filtration is 44 l/h for a maximum pressure of 25 bar. The maximum VCF achieved is 4.1. the water recovered contains neither aroma nor color.

This nanofiltration concentration makes it possible to reach a concentration close to that of reverse osmosis but with a lower operating pressure. The recovered water contained no dry matter, aroma or color.

### Example 3 Nanofiltration of Deacidified Cranberry Juice

The cranberry juice is similar to that of Example 1, but corresponds to another batch with a raw juice at a concentration of 7 brix. After deacidification, the brix of the juice is 5.2. This is related to the acid capture replaced by water and the dilution corresponding to the rinsing of the ion exchange column.

The nanofiltration membrane used was a Filmtec NF270 membrane and provided the results in the following table:

| Elapse Time | Press. | VOLUME (I) | | | Permeate Flow Rate | | | BRIX | | | |
|---|---|---|---|---|---|---|---|---|---|---|---|
| Minutes | BAR | Feed | Retent | Perm | l/h | l/h · m² | VCF | Retentate | Feed | Perm | ABS 420 nm |
| 0 | 15 | 20 | 20 | 0 | 121 | 44.8 | 1.0 | 5.2 | 5.2 | 0 | 0 |
| 5 | 15 | 30 | 20 | 10 | 117 | 43.3 | 1.5 | 7.7 | 5.2 | 0 | 0 |
| 10 | 15 | 39 | 20 | 19 | 113 | 41.9 | 2.0 | 10.2 | 5.2 | 0 | 0 |
| 15 | 15 | 48 | 20 | 28 | 110 | 40.7 | 2.4 | 12.6 | 5.2 | 0.1 | 0 |
| 20 | 15 | 57 | 20 | 37 | 103 | 38.1 | 2.8 | 14.8 | 5.2 | 0.1 | 0 |
| 25 | 15 | 65 | 20 | 45 | 96 | 35.6 | 3.2 | 16.9 | 5.2 | 0.1 | 0 |
| 30 | 15 | 72 | 20 | 52 | 88 | 32.6 | 3.6 | 18.8 | 5.2 | 0.1 | 0 |
| 35 | 15 | 79 | 20 | 59 | 77 | 28.5 | 3.9 | 20.5 | 5.2 | 0.2 | 0 |
| 40 | 15 | 84 | 20 | 64 | 64 | 23.7 | 4.2 | 21.8 | 5.2 | 0.2 | 0 |
| 45 | 20 | 88 | 20 | 68 | 50 | 18.5 | 4.4 | 22.9 | 5.2 | 0.2 | 0 |
| 50 | 25 | 89 | 18 | 71 | 38 | 14.1 | 5.0 | 25.8 | 5.2 | 0.3 | 0 |

A maximum concentration of 25.8 brix is reached in the retentate. We observe a slight loss of material in the permeate. The average flow rate of the filtration is 85 l/h for a maximum pressure of 25 bars. The maximum VCF achieved was 5.0. The recovered water had a floral aromatic smell.

This assay provided a greater concentration than by the reverse osmosis but with a lower operating pressure. The recovered water contained low amounts of dry matter, a slight aroma, but no color.

### Example 4 Nanofiltration of Deacidified Blackcurrant Juice

Blackcurrant juice is produced from blackcurrant type black burgundy. After grinding the grains, the juice is treated with enzyme (with a lafaze XL press pectinase), pressed and deacidified according to the method WO20180549004 A1. Raw juice at a concentration of 16 brix. After deacidification, the brix of the juice is only 13.4. this is related to the acid capture replaced by water and the dilution corresponding to the rinsing of the ion exchange column.

The membrane used was a filmtec NF270 2540 and provided the results in the following table:

| Elapse Time | Press. | VOLUME (I) | | | Permeate Flow Rate | | | BRIX | | | |
|---|---|---|---|---|---|---|---|---|---|---|---|
| Minutes | BAR | Feed | Retent | Perm | l/h | l/h · m² | VCF | Retentate | Feed | Perm | ABS 420 nm |
| 0 | 15 | 20 | 20 | 0 | 85 | 31.5 | 1.0 | 13.4 | 13.4 | 0 | 0 |
| 5 | 15 | 25 | 20 | 5 | 63 | 23.3 | 1.3 | 16.9 | 13.4 | 0 | 0 |
| 10 | 15 | 29 | 20 | 9 | 49 | 18.1 | 1.5 | 19.7 | 13.4 | 0.1 | 0 |
| 15 | 15 | 32 | 20 | 12 | 31 | 11.5 | 1.6 | 21.4 | 13.4 | 0.2 | 0 |
| 20 | 20 | 34 | 20 | 14 | 21 | 7.8 | 1.7 | 22.6 | 13.4 | 0.2 | 0 |
| 25 | 20 | 34 | 20 | 14 | 6 | 2.2 | 1.7 | 22.9 | 13.4 | 0.5 | 0.009 |

A maximum concentration of 22.9 brix is reached in the retentate. We observe a slight loss of material in the permeate. The average flow rate of the filtration is 33.6 l/h for a maximum pressure of 25 bars. The maximum VCF achieved is 1.7. The recovered water has a slight floral aromatic smell.

The recovered water contains a low dry matter, a slight aroma, but no color.

### Example 5 Nanofiltration of Deacidified Blackcurrant Juice

The blackcurrant juice is identical to that of Example 4. The raw juice has a concentration of 16 brix. After deacidification, the brix of the juice is only 13.4. this is related to the acid capture replaced by water and the dilution corresponding to the rinsing of the ion exchange column.

The membrane used was an NFW Synder and provided the results in the following table:

| Elapse Time | Press. | VOLUME (I) | | | Permeate Flow Rate | | | BRIX | | | |
|---|---|---|---|---|---|---|---|---|---|---|---|
| Minutes | BAR | Feed | Retent | Perm | l/h | l/h · m² | VCF | Retentate | Feed | Perm | ABS 420 nm |
| 0 | 12 | 20 | 20 | 0 | 95 | 35.2 | 1.0 | 13.4 | 13.4 | 0.3 | 0.00 |
| 5 | 12 | 25 | 20 | 5 | 65 | 24.1 | 1.3 | 17.0 | 13.4 | 0.7 | 0.05 |
| 10 | 15 | 29 | 20 | 9 | 42 | 15.6 | 1.4 | 19.4 | 13.4 | 0.9 | 0.06 |
| 15 | 15 | 31 | 20 | 11 | 29 | 10.7 | 1.6 | 21.0 | 13.4 | 1.1 | 0.09 |
| 20 | 20 | 33 | 20 | 13 | 16 | 5.9 | 1.6 | 21.9 | 13.4 | 1.4 | 0.11 |
| 25 | 20 | 33 | 20 | 13 | 3 | 1.1 | 1.6 | 22.1 | 13.4 | 2.7 | 0.18 |

The NFW membrane allowed to reach a concentration of 22.1 brix in the retentate with a 1.6 VCF. The average flow rate was 31 l/h. we observed a dry matter concentration of about 2.7 brix in the raffinate and a color intensity of 0.18 absorbance at 420 nm. This membrane lets part of the blackcurrant juice pass.

The aroma of the recovered water is close to that of the diluted blackcurrant.

### Example 6 Nanofiltration of Deacidified Pomegranate Juice

Pomegranate juice was obtained from concentrated juice. It was diluted to 10 brix and then deacidified by the process according to WO20180549004 A1. The resulting juice is slightly diluted by the combined effect of acid capture and rinsing of the ion exchange column.

The membrane used is a Filmtec NF270 and provided the results in the following table:

| Elapse Time | Press. | VOLUME (I) | | | Permeate Flow Rate | | | BRIX | | | |
|---|---|---|---|---|---|---|---|---|---|---|---|
| Minutes | BAR | Feed | Retent | Perm | l/h | l/h · m² | VCF | Retentate | Feed | Perm | ABS 420 nm |
| 0 | 15 | 20 | 20 | 0 | 102 | 37.8 | 1.0 | 9.3 | 9.3 | 0 | 0 |
| 5 | 15 | 28 | 20 | 8 | 97 | 35.9 | 1.4 | 13.1 | 9.3 | 0 | 0 |
| 10 | 15 | 35 | 20 | 15 | 86 | 31.9 | 1.8 | 16.4 | 9.3 | 0.1 | 0 |
| 15 | 15 | 40 | 20 | 20 | 61 | 22.6 | 2.0 | 18.8 | 9.3 | 0.1 | 0 |
| 20 | 15 | 44 | 20 | 24 | 43 | 15.9 | 2.2 | 20.4 | 9.3 | 0.2 | 0 |
| 25 | 25 | 46 | 20 | 26 | 22 | 8.1 | 2.3 | 21.3 | 9.3 | 0.3 | 0 |
| 30 | 25 | 47 | 20 | 27 | 10 | 3.7 | 2.3 | 21.7 | 9.3 | 0.4 | 0 |
| 35 | 25 | 47 | 20 | 27 | 4 | 1.5 | 2.3 | 21.8 | 9.3 | 0.4 | 0 |

The maximum concentration reached was 21.8 brix for an VCF of 2.3 at a maximum pressure of 25 bars. There is a slight passage of material in the permeate, but no color.

Characteristic aromas can be distinguished, apart from the acids present (acetic and citric), including acetaldehyde that is noted very distinctly, methyl 2 butanoic acid, and also several terpineols including alpha terpineol.

### Example 7 Comparative Nanofiltration of Cranberry Juice and Deacidified Cranberry Juice and Characterization of the Resulting Permeate (Water Drink)

Feed Juices in Nanofiltration Assays

The nanofiltration tests were performed on a cranberry juice previously deacidified by the process described in WO20180549004 A1 using the resin LEWATIT S5221 from LANXESS and on a crude (acidic) juice. The juices were prepared from a concentrate at 50.5° brix and diluted in demineralized water. The juice compositions were as follows:

| | Deacidified Juice | Crude Juice | |
|---|---|---|---|
| Brix | 6.5 | 6.5 | ° B |
| pH | 3.56 | 2.50 | |
| Citric acid | 3.10 | 10.38 | g/l |
| Quinic acid | 12.53 | 11.67 | g/l |
| Malic acid | 9.64 | 10.37 | g/l |
| Glucose | 33.63 | 28.97 | g/l |
| absorbance* (280 nm) | 17.0 | 16.0 | UA |
| absorbance* (420 nm) | 0.790 | 0.790 | UA |
| absorbance* (520 nm) | 0.830 | 0.640 | UA |
| absorbance*(620 nm) | 0.000 | 0.060 | UA |

Nanofiltration Membranes

Four different membranes were tested in these assays:

| | Cutoff (Da) | Model | Manufacturer | Size (cm) |
|---|---|---|---|---|
| 1 | 600-800 | NFG | SYNDER | 17 × 7.5 |
| 2 | 500-700 | NDX | | (0.013 m²) |
| 3 | 300-500 | NFW | | |
| 4 | About 300 | FILMTEC ™ NF270 | DUPONT | |

The same equipment as what is described above in “Reverse Osmosis/nanofiltration set up” was used

Analytical Method:

The organic acids and sugars analysis was done by HPLC using a BIORAD HPX87H column of 7.8×300 mm and with a mobile phase that is an 8 mM aqueous H₂SO₄ solution eluted at a rate of 0.6 ml/min in the column at 50° C.

The dry matter was measured using refraction and the absorbance was measured by absorption in the UV-visible using a spectrophotometer at 420, 520, 620 and 280 nm.

The absorbance was measured at 280 nm which is proportional to the carbon-carbon double bond concentration, which are specific for polyphenols. By extension, we consider that this absorbance is proportional to the concentration of proanthocyanides. The sum of the absorbances at 420, 520 and 620 nm gives the intensity of the solution. The 420/520 nm ratio determines the shade.

Nanofiltration

Two filtrations tests were performed: one with a deacidified juice (pH 3.5) and a second one with a crude juice (pH 2.5). The concentration of the raw juice was adjusted according to that of the deacidified juice after the Witurbo process.

Filtration is carried out at a maximum circulation rate of 200 l/h at 15 bar. The temperature is maintained in the feed tank at 35° C. Filtration is continued until about 500 ml of permeate*(aromatic waters) are obtained. The filter area of each membrane is 0.013 m².

At the end of each test, four permeates and one common retentate are obtained. The analysis of the fractions makes it possible to calculate a material balance.

Deacidified Cranberry Juice

The total duration of the test was 330 minutes. The test was started under conditions of pressure/temperature different from those described above, however from FCV=1.13, the temperature was set at 35° C. and the pressure set at 15 bar to increase the permeate flow. NFG gives the highest average permeate flow. The average pass rate is also the highest (17%). The table below shows that the NDX membrane gave the lowest flow rate and the NF270 the lowest pass rate (6%).

The overall material balance is accounted for. There is a higher retention of citric acid with NF270 (3%) compared to SYNDER membranes which may explain the higher permeate pH (4.04). SYNDER membranes have a higher average pass rate than those of NF270; however, it is found that the difference is smaller with malic acid. NFW has the highest shading resulting in slightly more yellow permeate than other permeates.

| | | | permeate. | | | | A | | | | | | concentration g/l | | | |
|---|---|---|---|---|---|---|---|---|---|---|---|---|---|---|---|---|
| | | | avg | | | | (filtered - 0.45 μm) | | | | | | (% passage) | | | |
| | | cutoff | l/h · | V | brix | | 420 | 520 | 620 | 280 | inten- | nu- | glu- | | | |
| | fraction | Da | m⁻² | I | °B | pH | nm | nm | nm | nm | sity | ance | cose | citric | malic | total |
| IN | ALIMEN- | | | 6.00 | 6.5 | 3.56 | 0.79 | 0.64 | 0.06 | 16 | 1.49 | 1.23 | 33.63 | 5.10 | 9.64 | 66.62 |
| | TATION | | | | | | | | | | | | | | | |
| OUT | PERMEAT | 600- | 8.98 | 0.63 | 1.1 | 3.56 | 0.016 | 0.005 | 0.002 | 2.3 | 0.023 | 3.20 | 4.32 | 1.35 | 2.99 | 11.1 |
| | NFG | 800 | | | | | | | | | | | (13%) | (26%) | (31%) | (17%) |
| | PERMEAT | 500- | 2.14 | 0.15 | 0.7 | 3.74 | 0.008 | 0.005 | 0.001 | 2.13 | 0.014 | 1.60 | 2.53 | 0.60 | 2.53 | 7.02 |
| | NDX | 700 | | | | | | | | | | | (8%) | (12%) | (26%) | (11%) |
| | PERMEAT | 300- | 5.88 | 0.41 | 0.8 | 3.52 | 0.017 | 0.002 | 0 | 2.01 | 0.019 | 8.50 | 2.73 | 1.02 | 2.62 | 8.02 |
| | NFW | 500 | | | | | | | | | | | (8%) | (20%) | (27%) | (12%) |
| | PERMEAT | 300 | 6.99 | 0.49 | 0.4 | 4.04 | 0.027 | 0.015 | 0.013 | 1.66 | 0.055 | 1.80 | 1.08 | 0.16 | 1.97 | 4.01 |
| | NF270 | | | | | | | | | | | | (3%) | (3%) | (20%) | (6%) |
| | RETENT- | | | 4.37 | 8.4 | 3.56 | 1.12 | 0.86 | 0.09 | 24.7 | 2.07 | 1.30 | 44.22 | 6.50 | 11.99 | 86.72 |
| | ATE | | | | | | | | | | | | | | | |
| OUT/ | | | | 98% | | | | | | | | | 98% | 98% | 98% | 98% |
| IN | | | | | | | | | | | | | | | | |

Crude Cranberry Juice

The total duration of the test is 420 minutes. As shown in the table below, the NFG membrane gives the average permeate flow rate and the pass rate (14%). The NDX gives the lowest flow rate and the NFW the lowest pass rate (6%) like the first test.

The overall material balance is accounted. In this second test, average flow rates lower than the first one indicate a clogging of the filtration membranes despite a lower final FCV. NFG and NF270 have similar average rates on this test.

The rates of passage of malic acid are close to those found on the first test. They vary between 21 and 31% depending on the membrane. Like the first test we have a lower average pass rate on the NF270 with a smaller difference for malic acid. The rate of glucose passage is lower may be due to its lower proportion in the feed solution.

| | | | permeate. | | | | A | | | | | | concentration g/l | | | |
|---|---|---|---|---|---|---|---|---|---|---|---|---|---|---|---|---|
| | | | avg | | | | (filtered - 0.45 μm) | | | | | | (% passage) | | | |
| | | cutoff | l/h · | V | brix | | | | | | inten- | nu- | glu- | | | |
| | fraction | Da | m⁻² | I | °B | pH | 420 | 520 | 620 | 280 | sity | ance | cose | citric | malic | total |
| IN | ALIMEN- | | | 5.68 | 6.5 | 2.50 | 0.79 | 0.83 | 0 | 17 | 1.62 | 0.95 | 28.97 | 10.38 | 10.37 | 66.62 |
| | TATION | | | | | | | | | | | | | | | |
| OUT | PERMEAT | 600- | 5.16 | 0.57 | 0.9 | 2.50 | 0.033 | 0.014 | 0.009 | 2.01 | 0.056 | 2.36 | 1.78 | 2.48 | 3.21 | 9.03 |
| | NFG | 800 | | | | | | | | | | | (6%) | (24%) | (31%) | (14%) |
| | PERMEAT | 500- | 1.30 | 0.14 | 0.5 | 2.53 | 0.038 | 0.021 | 0.015 | 2.78 | 0.074 | 1.81 | 0.72 | 0.98 | 2.57 | 5.01 |
| | NDX | 700 | | | | | | | | | | | (2%) | (9%) | (25%) | (8%) |
| | PERMEAT | 300- | 3.73 | 0.41 | 0.5 | 2.46 | 0.025 | 0.009 | 0.005 | 1.92 | 0.039 | 2.78 | 0.52 | 1.24 | 2.62 | 5.01 |
| | NFW | 500 | | | | | | | | | | | (2%) | (12%) | (25%) | (8%) |
| | PERMEAT | 300 | 5.07 | 0.56 | 0.4 | 2.64 | 0.049 | 0.027 | 0.025 | 2.87 | 0.101 | 1.81 | 0.70 | 0.42 | 2.20 | 4.01 |
| | NF270 | | | | | | | | | | | | (2%) | (4%) | (21%) | (6%) |
| | RETENT- | | | 4.39 | 8.1 | 2.52 | 1.14 | 1.19 | 0.05 | 24 | 2.38 | 0.96 | 37.0 | 12.79 | 12.34 | 83.53 |
| | ATE | | | | | | | | | | | | | | | |
| OUT/ | | | | 100% | | | | | | | | | 100% | 100% | 100% | 100% |
| IN | | | | | | | | | | | | | | | | |

While the description has been described in connection with specific embodiments thereof, it will be understood that it is capable of further modifications and this application is intended to cover any variations, uses, or adaptations and including such departures from the present disclosure as come within known or customary practice within the art and as may be applied to the essential features hereinbefore set forth, and as follows in the scope of the appended claims.

1. An aromatic water drink obtained from a fruit juice comprising a reduced Brix degree of at least 50% compared to the fruit juice.

2. The aromatic water drink of claim 1, wherein said aromatic water drink is produced following the steps of:
providing a fruit juice,
performing a nanofiltration of said fruit juice or adjusted fruit juice through a nanofiltration membrane; and
recovering the permeate water from said nanofiltration to obtain said aromatic water drink, wherein the permeate water has a reduced Brix degree by at least 50% compared to the fruit juice.

3. The aromatic water drink of claim 1, wherein the fruit just is an adjusted fruit juice.

4. The aromatic water drink of claim 3, wherein the adjusted fruit juice has been pH adjusted.

5. The aromatic water drink of claim 1, wherein the permeate water has a Brix degree reduced by at least about 70%.

6. The aromatic water drink of claim 1, wherein the permeate water has a Brix degree reduced by at least about 85%.

7. The aromatic water drink of claim 1, wherein the permeate water has a Brix degree reduced by at least about 90-95%.

8. The aromatic water drink of claim 1, wherein the permeate water has a glucose concentration reduced by at least 50% relative to the glucose concentration of the fruit juice.

9. The aromatic water drink of claim 1, wherein the permeate water has a glucose concentration reduced by at least about 70%.

10. The aromatic water drink of claim 1, wherein the permeate water has a glucose concentration reduced by at least about 85%.

11. The aromatic water drink of claim 1, wherein the permeate water has a glucose concentration reduced by at least about 90-95%.

12. The aromatic water drink of claim 1, wherein said fruit juice is at least one of cranberry juice, pomegranate juice, pineapple juice, Camerise juice, Blackcurrant juice, Redcurrant juice, Blueberry juice, Blackberry juice, Strawberry juice, Raspberry juice, Acai juice, Acerola juice, Goji berry juice, Cynorhodon juice, Arbutus juice, Myrtle juice, Guarana juice, Coffee berry juice, Cola nuts juice, maracuja juice, goyava juice, mango juice, apple juice, pear juice, peach juice, plume juice, blood-orange grapefruit juice, lemon juice, lime juice, mandarin juice, clementine juice or tangerine juice.

13. The aromatic water drink of claim 1, wherein the fruit juice has a brix concentration from 3 to 15.

14. The aromatic water drink of claim 1, wherein the fruit juice has a brix concentration of 5 to 10.

15. The aromatic water drink of claim 1, wherein the nanofiltration membrane has a cut-off threshold of from about 300-800 Da.

16. The aromatic water drink of claim 1, wherein the nanofiltration membrane has a cut-off threshold from about 300-500 Da.

17. The aromatic water drink of claim 1, wherein the nanofiltration membrane has a cut-off threshold from about 500-700 Da.

18. The aromatic water drink of claim 1, wherein the nanofiltration membrane has a cut-off threshold from about 600-800 Da.

19. The aromatic water drink of claim 1, wherein the nanofiltration membrane is Filmtec NF90, Filmtec NF270, NFW Synder, Trisep NP10, NFG Synder, or NDX Synder.

20. The water drink of claim 1, wherein said aromatic water drink is incorporated in a sparkling water, a syrup, a soft drink, an ice cream, a sorbet, a yogurt or fresh cheese.
